(19) United States
(12) Patent Application Publication
(10) Pub. No.: US 2018/0085835 A1
(43) Pub. Date: Mar. 29, 2018

(54) TWO-WAY MILLING CUTTER

(71) Applicant: Ming-Kung WU, Taichung City (TW)

(72) Inventor: Ming-Kung WU, Taichung City (TW)

(21) Appl. No.: 15/497,206

(22) Filed: Apr. 26, 2017

(30) Foreign Application Priority Data
Sep. 29, 2016 (TW) 105131214

(51) Int. Cl. B23C 5/10; B23C 5/00

(52) U.S. Cl. CPC B23C 5/10; B23C 5/006; B23C 2226/27; B23C 2210/0485; B23C 2210/486; B23C 2210/20

(57) ABSTRACT

A milling cutter includes a cutting section extending from a shank along an axis. The shank includes a free end as a first end of the milling cutter. The cutting section includes a free end as a second end of the milling cutter. The cutting section includes at least one right-hand cutting unit, at least one left-hand cutting unit and at least two grooves about the axis. Each of the grooves is made between the right-hand cutting unit and the left-hand cutting unit. The right-hand cutting unit includes several right-hand blades extending at a first helical angle relative to the axis. The left-hand cutting unit includes several left-hand blades extending at a second helical angle relative to the axis.

### BACKGROUND OF THE INVENTION

### 1. Field of the Invention

The present invention relates to a milling cutter for a work-piece of carbon fibers and, more particularly, to a two-way milling cutter operable to make a hole in a work-piece of carbon fibers and render the wall of the hole smooth.

### 2. Related Prior Art

A conventional milling cutter can be used to make a hole in a work-piece made of carbon fibers. However, there is a problem with the use of the milling cutter to cut the work-piece. That is, burs occur on the wall of the hole so that the precision in the dimension of the hole is poor. The burs must be removed later to improve the precision. A reason for the occurrence of the burs is a combination of the ability of the milling cutter with the extension of the carbon fibers. The milling cutter can only cut neatly in a sense of direction, but cannot cut neatly in an opposite sense of direction. To make the work-piece, the carbon fibers are woven and hence extend in various senses of direction. The milling cutter cuts the carbon fibers neatly without producing many burs if the sense of direction of the milling cutter is compliant to the sense of direction of the carbon fibers. However, the milling cutter inevitably tears, instead of cuts, some of the carbon fibers and hence produces quite a few burs if the sense of direction of the milling cutter is not compliant to the sense of direction of the carbon fibers. There is another problem with the use of the milling cutter to cut the work-piece. That is, debris of the carbon fibers might fill gaps between groups of blades of the milling cutter and hence interfere with the cutting.

The present invention is therefore intended to obviate or at least alleviate the problems encountered in prior art.

### SUMMARY OF INVENTION

It is an objective of the present invention to provide a milling cutter for neatly cutting a work-piece made of carbon fibers without producing many burs.

It is another objective of the present invention to provide a milling cutter for smoothly cutting a work-piece made of carbon fibers.

To achieve the foregoing objectives, the milling cutter includes a cutting section extending from a shank along an axis. The shank includes a free end as a first end of the milling cutter. The cutting section includes a free end as a second end of the milling cutter. The cutting section includes at least one right-hand cutting unit, at least one left-hand cutting unit and at least two grooves about the axis. Each of the grooves is made between the right-hand cutting unit and the left-hand cutting unit. The right-hand cutting unit includes several right-hand blades extending at a first helical angle relative to the axis. Each of the right-hand blades includes a leading face facing the first end of the milling cutter, a following face, and a cutting edge between the leading face and the following face. The left-hand cutting unit includes several left-hand blades extending at a second helical angle relative to the axis. Each of the left-hand blades includes a leading face facing the second end of the milling cutter, a following face, and a cutting edge between the leading face and the following face.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is a perspective view of a milling cutter according to the first embodiment of the present invention;

FIG. 2 is a perspective view of the milling cutter shown in FIG. 1;

FIG. 3 is a front view of the milling cutter shown in FIG. 1;

FIG. 4 is a rear view of the milling cutter shown in FIG. 1;

FIG. 5 is a left side view of the milling cutter shown in FIG. 1;

FIG. 6 is a right side view of the milling cutter shown in FIG. 1;

FIG. 7 is an enlarged partial view of the milling cutter shown in FIG. 1;

FIG. 8 is an enlarged partial cross-sectional view of the milling cutter shown in FIG. 7, showing right-hand cutting blades;

FIG. 9 is an enlarged partial cross-sectional view of the milling cutter shown in FIG. 7, showing left-hand cutting blades;

FIG. 10 is a top view of the milling cutter shown in FIG. 1;

FIG. 11 is a perspective view of a milling cutter according to the second embodiment of the present invention;

FIG. 12 is a perspective view of the milling cutter shown in FIG. 11;

FIG. 13 is a front view of the milling cutter shown in FIG. 11;

FIG. 14 is a left side view of the milling cutter shown in FIG. 11; and

FIG. 15 is a top side view of the milling cutter shown in FIG. 11.

### DETAILED DESCRIPTION OF EMBODIMENTS

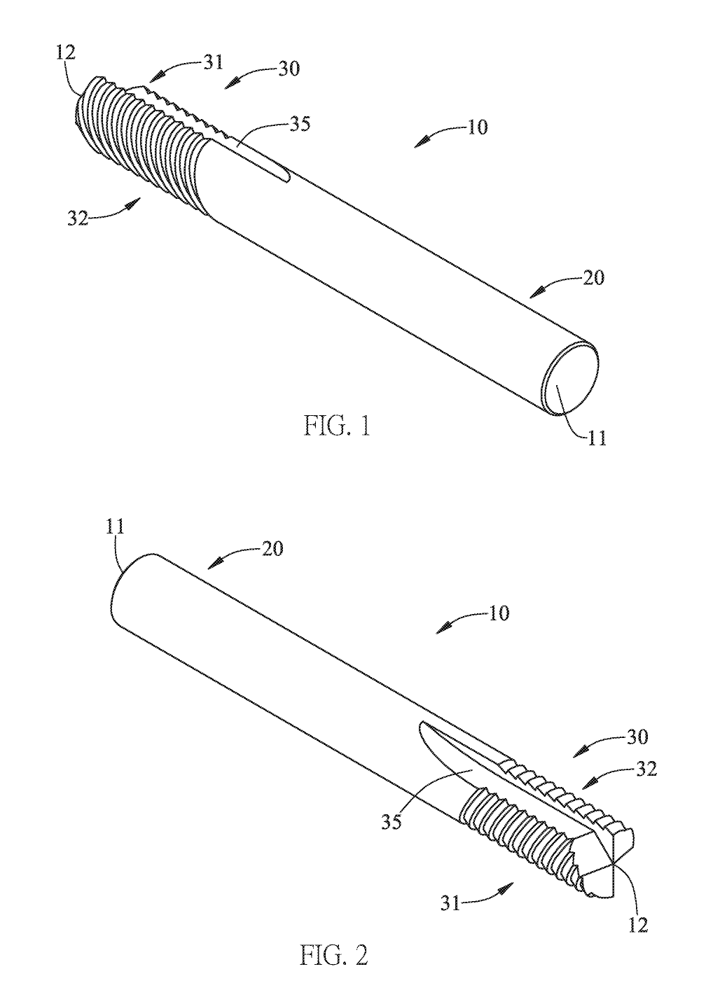

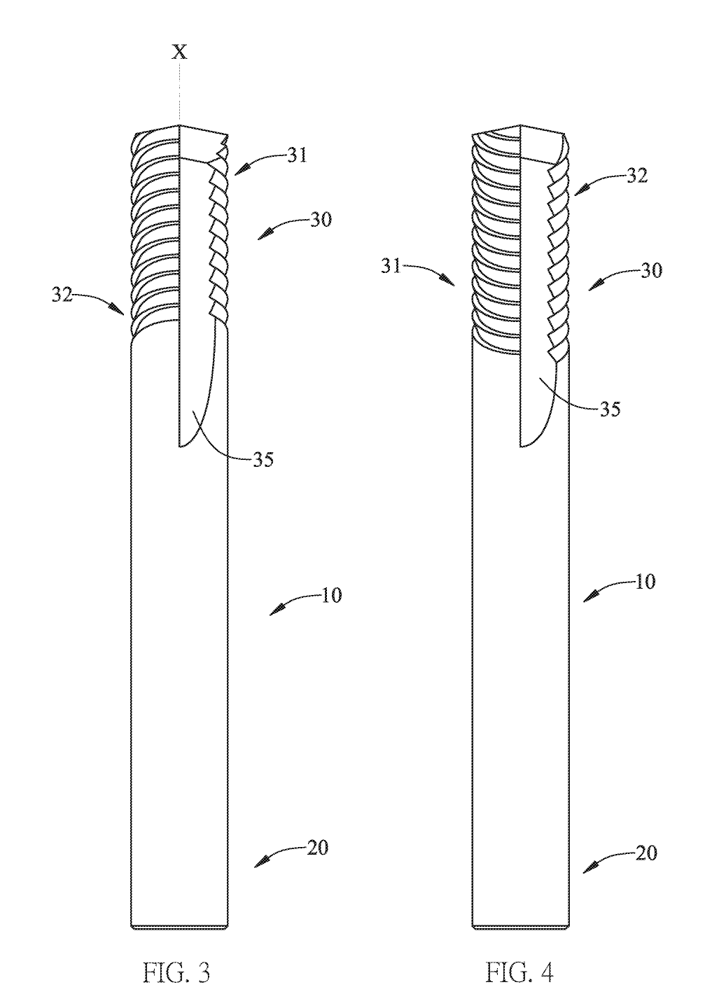

Referring to FIGS. 1 to 4, a milling cutter 10 includes a cutting section 30 extending from a shank 20 according to a first embodiment of the present invention. The shank 20 and the cutting section 30 extend along a common axis X. The shank 20 includes a free end that will be referred to as the first end 11 of the milling cutter 10. The cutting section 30 includes a free end that will be referred to as the second end 12 of the milling cutter 10. On the periphery, the cutting section 30 includes at least one right-hand cutting unit 31, at least one left-hand cutting unit 32 and two parallel grooves 35. Each of the grooves 35 is made between the right-hand cutting unit 31 and the left-hand cutting unit 32 (FIG. 10).

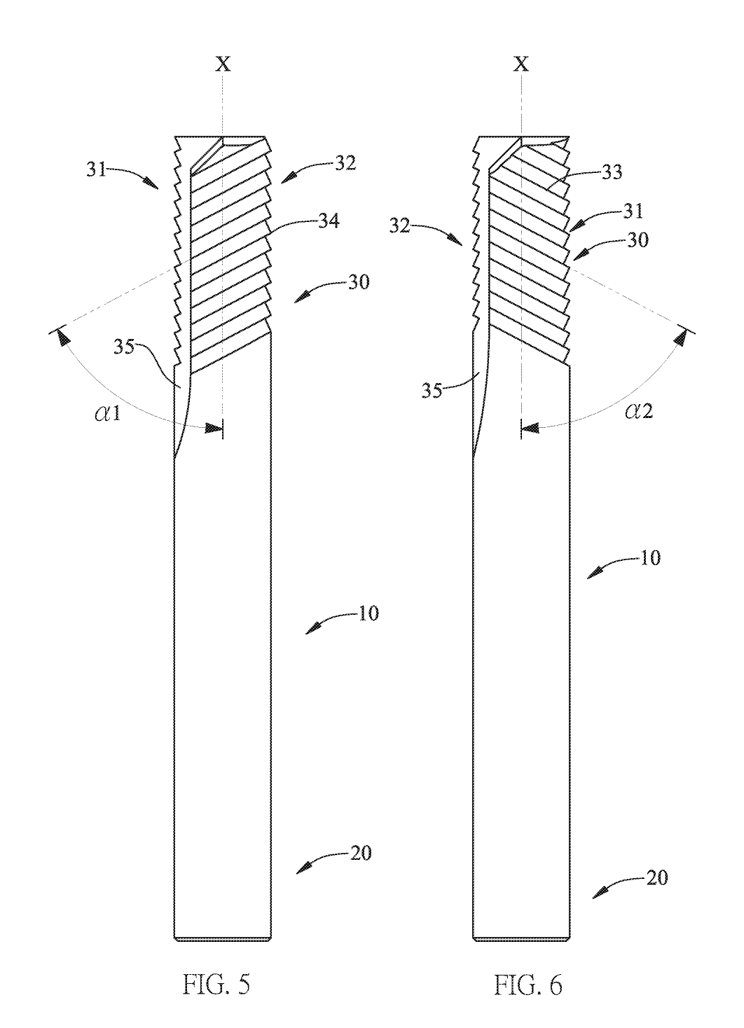

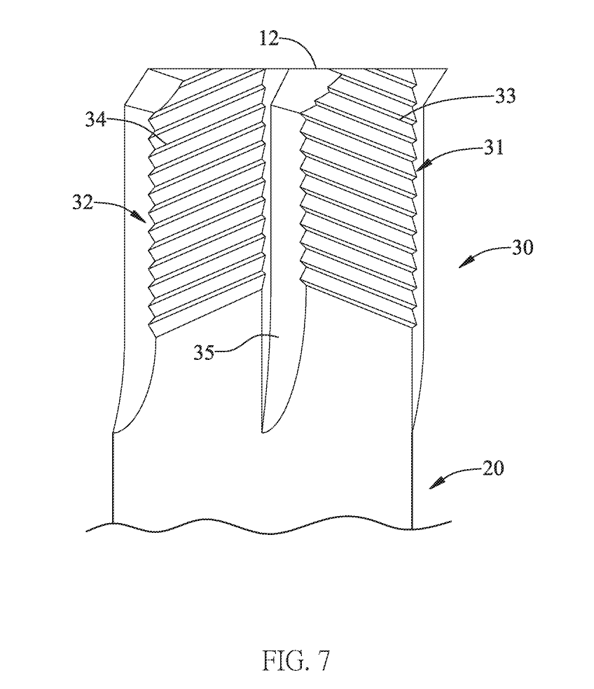

Referring to FIGS. 5 through 7, the right-hand cutting unit 31 includes several right-hand blades 33. The left-hand cutting unit 32 includes several left-hand blades 34. All of the blades 33 and 34 extend about the axis X. The right-hand blades 33 extend at a helical angle α1 relative to the axis X. The left-hand blades 34 extend at a helical angle α2 relative to the axis X. The helical angles α1 and α2 can be identical to each other or not.

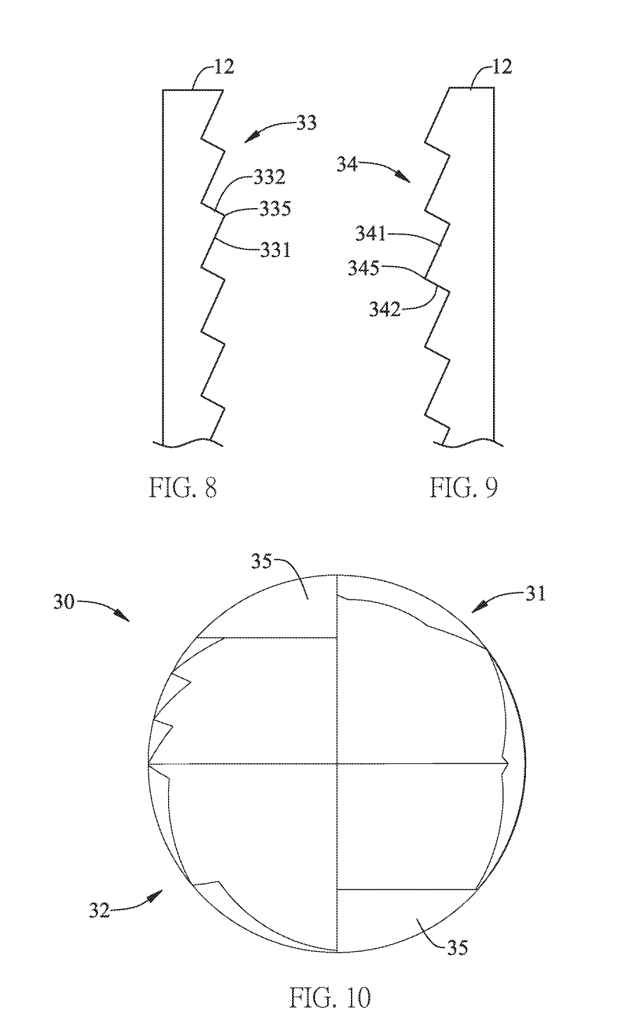

Referring to FIG. 8, each of the right-hand blades 33 includes a leading face 331, a following face 332 and a cutting edge 335 between the leading face 331 and the following face 332. The leading face 331 of each of the right-hand blades 33 faces the first end 11 of the milling cutter 10.

Referring to FIG. 9, each of the left-hand blades 34 includes a leading face 341, a following face 342 and a cutting edge 345 between the leading face 341 and the following face 342. The leading face 341 of each of the left-hand blades 34 faces the second end 12 of the milling cutter 10.

However, in another embodiment, the leading face 331 of each of the right-hand blades 33 faces the second end 12 of the milling cutter 10, and the leading face 341 of each of the left-hand blades 34 faces the first end 11 of the milling cutter 10.

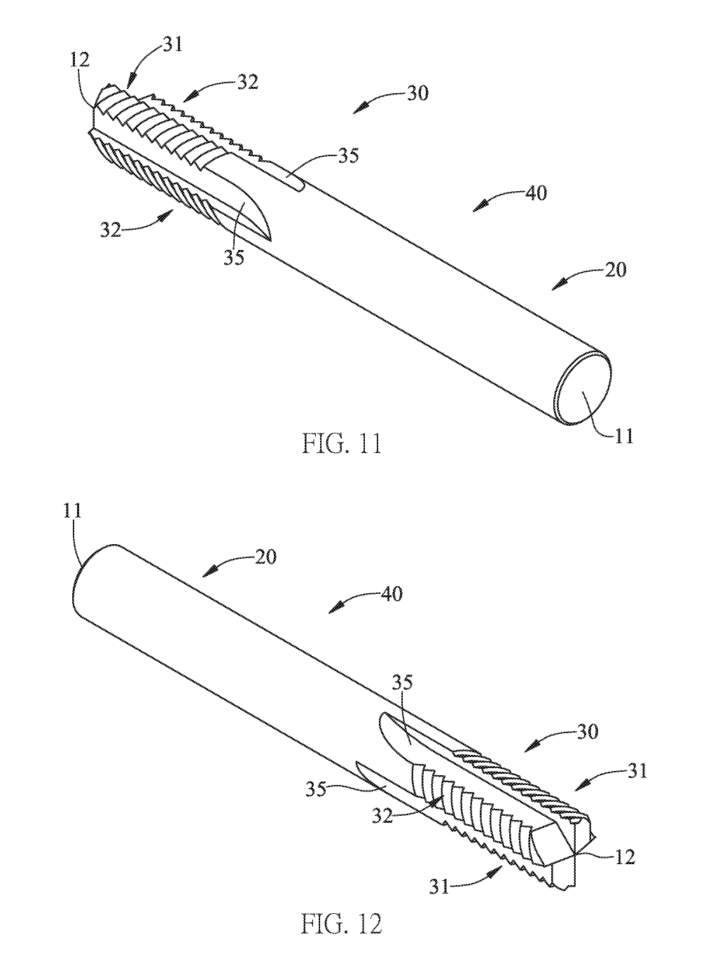

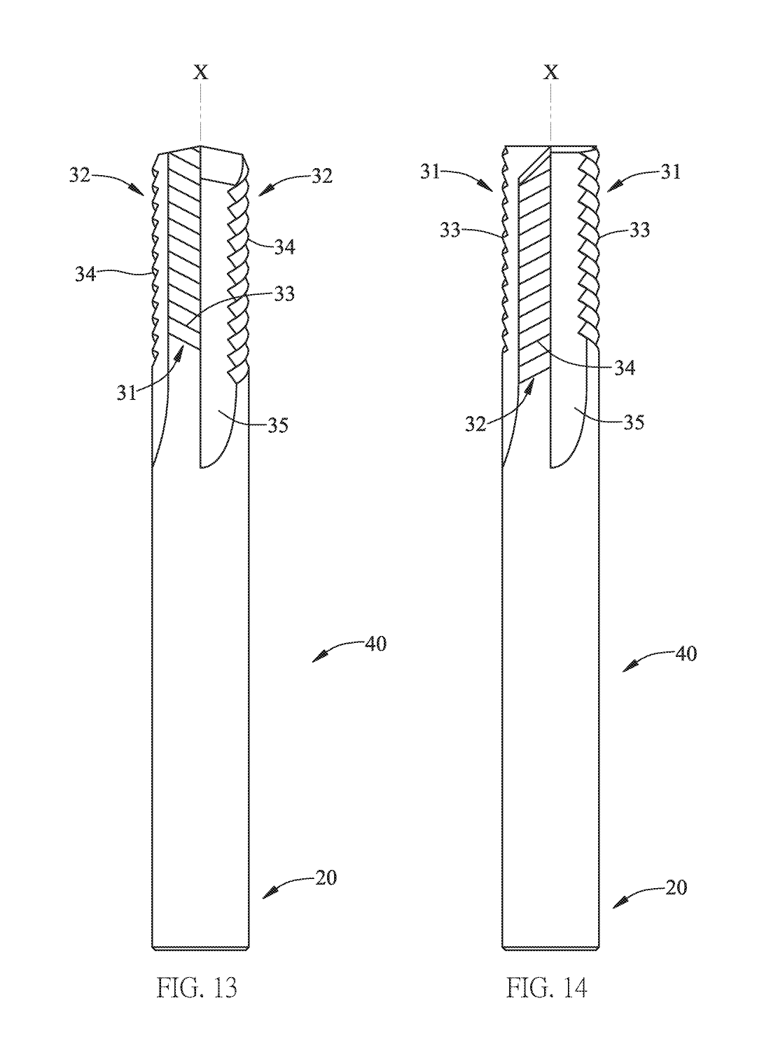

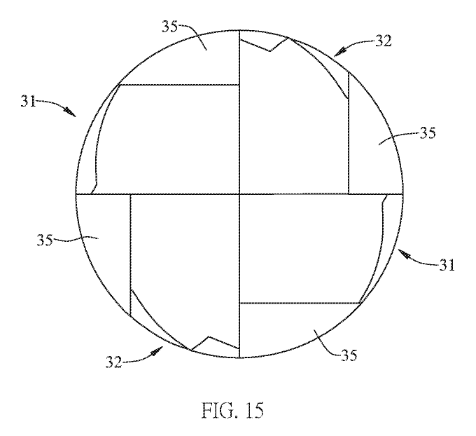

Referring to FIGS. 11 to 15, there is a milling cutter 40 according to a second embodiment of the present invention. The milling cutter 40 is like the milling cutter 10 except for that the cutting section 30 includes two right-hand cutting units 31 and two left-hand cutting units 32. The right-hand cutting units 31 are alternatively arranged with the left-hand cutting units 32. Accordingly, there are four grooves 35. Each of the grooves 35 is made between one of the right-hand cutting units 31 and one of the left-hand cutting units 32.

In use, the shank 20 of the milling cutter 10 or 40 is connected to a pneumatic or electric rotating tool. The rotating tool rotates the milling cutter 10 or 40 in a sense of direction. Hence, where the milling cutter 10 or 40 is used to cut a hole in a work-piece made by weaving carbon fibers, the right-hand blades 33 or the left-hand blades 34 are able to smoothly and neatly cut, not tear, in a right-hand or left-hand manner regardless of the sense of direction of the extension of a carbon fiber, i.e., the milling cutter 10 or 40 is able to smoothly and neatly cut a hole in the work-piece without producing many burs on the wall of the hole. Hence, the dimension of the hole is precise. Moreover, debris of the carbon fibers can easily be moved out of the hole through the grooves 35, without interfering with the cutting. Hence, the cutting is smooth.

The present invention has been described via the illustration of the embodiments. Those skilled in the art can derive variations from the embodiments without departing from the scope of the present invention. Therefore, the embodiments shall not limit the scope of the present invention defined in the claims.

1. A milling cutter comprising a shank (20) and a cutting section (30) connected to the shank (20), the shank (20) comprising a free end as a first end (11) of the milling cutter, the cutting section (30) comprising a free end as a second end (12) of the milling cutter, the shank (20) and the cutting section (30) comprising a same rotational axis, the milling cutter being characterized by:
the cutting section (30) comprising at least one right-hand cutting unit (31) and at least one left-hand cutting unit (32) about the rotational axis, at least one groove (35) being made between the right-hand cutting unit (31) and the left-hand cutting unit (32) for containing debris and separating;
the right-hand cutting unit (31) comprising several right-hand blades (33), the left-hand cutting unit (32) comprising several left-hand blade (34), each of the right-hand and left-hand blades (33, 34) extending at a helical angle relative to the rotational axis;
each of the right-hand and left-hand blades (33, 34) comprising a leading face (331, 341) and a following face (332, 342), the leading face (331, 341) intersects the following face (332, 342) to form a cutting edge (335, 345), the leading face (331) of each of the right-hand blade (33) faces the second end of the milling cutter, the leading face (341) of each of the left-hand blade (34) faces the first end of the milling cutter.

2. A milling cutter comprising a shank (20) and a cutting section (30) connected to the shank (20), the shank (20) comprising a free end as a first end (11) of the milling cutter, the cutting section (30) comprising a free end as a second end (12) of the milling cutter, the shank (20) and the cutting section (30) comprising a same rotational axis, the milling cutter being characterized by:
the cutting section (30) comprising at least one right-hand cutting unit (31) and at least one left-hand cutting unit (32) about the rotational axis, at least one groove (35) being made between the right-hand cutting unit (31) and the left-hand cutting unit (32) for containing debris and separating;
the right-hand cutting unit (31) comprising several right-hand blades (33), the left-hand cutting unit (32) comprising at least one left-hand blade (34), each of the right-hand and left-hand blades (33, 34) extending at a helical angle relative to the rotational axis;
the cutting section (30) comprising two right-hand cutting units (31) and two left-hand cutting units (32) about the rotational axis, the right-hand cutting units (31) being adjacent to the left-hand cutting units (32), with the groove (35) located between them.

3. The milling cutter according to claim 1 or 2, wherein the helical angle of the right-hand blades (33) and the helical angle of the left-hand blades (34) are identical.

4. The milling cutter according to claim 1 or 2, wherein the helical angle of the right-hand blades (33) and the helical angle of the left-hand blades (34) are different.

5. The milling cutter according to claim 1 or 2, wherein the cutting section (30) comprises two right-hand cutting units (31) and two left-hand cutting units (32) about the rotational axis, and the right-hand cutting units (31) are adjacent to the left-hand cutting units (32), with the groove (35) located between them.
